(19) United States
(12) Patent Application Publication
(10) Pub. No.: US 2025/0159489 A1
(43) Pub. Date: May 15, 2025

(54) Method and Apparatus for Managing Use of Communications Spectrum for Radar Sensing by Mobile Radar Devices

(71) Applicant: Telefonaktiebolaget LM Ericsson (publ), Stockholm (SE)

(72) Inventors: Magnus Sandgren, Staffanstorp (SE); Henrik Sjöland, Lund (SE); Andres Reial, Höllviken (SE)

(21) Appl. No.: 18/838,787

(22) PCT Filed: Mar. 1, 2022
(86) PCT No.: PCT/EP2022/055111

§ 371 Date: Aug. 15, 2024

(51) Int. Cl. H04W 16/14

(52) U.S. Cl. CPC H04W 16/14

(57) ABSTRACT

Techniques embodied in methods and apparatus disclosed herein provide mechanisms for communicating with one or more wireless communication networks (16), to identify the availability of licensed communication resources (18) for radar-sensing operations in geographic areas (20) that are outside of or between network coverage areas where those resources are used for communication services. Managing the usage of such resources by mobile radar devices (22) in these out-of-coverage areas provides a multiplicity of benefits, such as providing additional spectrum for radar-sensing usage, while providing a means to prevent conflicting usage with respect to the network coverage areas, or otherwise to coordinate with the involved networks (16) with respect to mobile radar devices (22) moving into and out of the out-of-coverage areas. Such management also offers advantages with respect to evolving or changing borders between coverage areas and out-of-coverage areas.

### TECHNICAL FIELD

According to a disclosed method and apparatus, licensed communication resources are identified as being available in a geographic area for radar-sensing operations and are managed with respect to usage by mobile radar devices operating in the area.

### BACKGROUND

Radar sensors provide vehicles with critical information about nearby vehicles, obstructions, etc., and play a pivotal role in vehicle safety and driving systems, such as where radar sensing provides information for automated distance-keeping between vehicles traveling in the same direction along a roadway. Radar-equipped vehicles represent one type of “mobile radar devices,” with the phrase referring more broadly to any mobile device that performs radar-sensing operations—i.e., any mobile device that emits radar signals and processes the corresponding return signals for environmental sensing or other purposes. Mobile radar devices often integrate communication circuitry or are embedded in larger platforms that include communication circuitry, thus providing a basis for mobile radar devices to communicate with each other or with other systems accessible through cellular or other wireless networks.

Increasingly common deployment of mobile radar devices raises concerns regarding inter-device interference and questions about how to manage mobile radar devices. An approach proposed in U.S. Pub. 2019/0387410 A1 addresses concerns specifically in the context of radar-equipped vehicles. “Cells” are defined within a larger geographic area and different transmission are allocated within proximate cells, to avoid radar interference between vehicles.

Greater complexity arises in the context of interference management when the communication resources used for radar-sensing operations are the same as or overlap with those used for cellular communications or other communication operations. The potential for conflicting usage of transmission resources for radar-sensing operations and communication operations increases as Mobile Network Operators (MNOs) begin licensing higher-frequency spectrum and deploying wireless communication networks that use these higher frequencies to provide network coverage in corresponding geographic areas. U.S. Pub. 2020/0107249 A1 discloses an example approach where base stations in a communication network respond to requests for transmission resources for radar operations.

“Transmission resources” comprise or are based on radio frequencies or frequency bands, although various forms of multiplexing—e.g., time, frequency, spatial, code—may be used to increase the number or amount of transmission resources provided by a given amount of radiofrequency (RF) spectrum. “Licensed communication resources” refers to transmission resources formed from RF spectrum that is owned or otherwise licensed. “Higher frequencies” refers to frequencies in the electromagnetic spectrum that are useful for radar sensing, in addition to being useful for evolving communication applications, such as ultra-low latency communications (ULLC), high-data rate communications, etc. One aspect of communication services based on higher frequencies is that coverage may be spotty or discontinuous, e.g., deployment of higher-frequency base stations and corresponding network coverage may be focused in urban areas or on an as-needed basis.

As an example, RF bands associated with licensed operation in the context of Fifth Generation (5G) New Radio (NR) networks include a first frequency range that is referred to as “FR1” and includes sub-6 GHz bands, and a second frequency range that is referred to as “FR2-1” by the Third Generation Partnership Project (3GPP) and includes frequency bands from 24.25 GHz to 52.6 GHz. In this example context, the FR2-1 bands, which extend into the millimeter-wave (mmW) range, may be considered to be higher-frequency spectrum. Particularly, the FR2-1 frequencies above 24 GHz may be useful for radar-sensing operations.

Known mitigations addressing usage of licensed communication resources in the same area for both communication operations and radar-sensing operations include the use of “beam management” to avoid interference between radio beams used for radar and radio beams used for communications. Additional or alternative mitigations that are known include scheduling the use of licensed communication resources applicable to a given geographic area, to avoid conflicting usage of those resources between radar-sensing operations and communication operations. However, such mitigations in some sense constrain one or both communication operations and radar-sensing operations, such as by limiting the times or directions in which radar sensing can be performed, or by limiting the overall capacity of the wireless communication network within the involved network coverage areas, to account for radar-sensing operations.

### SUMMARY

Techniques embodied in methods and apparatus disclosed herein provide mechanisms for communicating with one or more wireless communication networks, to identify the availability of licensed communication resources for radar-sensing operations in geographic areas that are outside of or between network coverage areas where those resources are used for communication services. Managing the usage of such resources by mobile radar devices in these out-of-coverage areas provides a multiplicity of benefits, such as providing additional spectrum for radar-sensing usage, while providing a means to prevent conflicting usage with respect to the network coverage areas, or otherwise to coordinate with the involved networks with respect to mobile radar devices moving into and out of the out-of-coverage areas. Such management also offers advantages with respect to evolving or changing borders between coverage areas and out-of-coverage areas.

An example embodiment comprises a method performed by a computer apparatus operating as a centralized management entity. The method includes the computer apparatus receiving spectrum usage information from one or more wireless communication networks that are separate from the centralized management entity, and identifying, from the spectrum usage information, first licensed communication resources that are available in a geographic area for radar-sensing operations. The method further includes the computer apparatus managing usage of the first licensed communication resources for radar-sensing operations by mobile radar devices operating in the geographic area as managed devices with respect to the centralized management entity. Managing comprises sending grant signaling for individual ones of the managed devices, the grant signaling granting usage of the first licensed communication resources by individual ones of the managed devices.

Another example embodiment comprises a computer apparatus operating as a centralized management entity. The computer apparatus includes communication interface circuitry and processing circuitry. The communication interface circuitry is configured to send and receive signaling via one or more wired or wireless connections, and the processing circuitry is operatively associated with the communication interface circuitry. The processing circuitry is configured to receive spectrum usage information from one or more wireless communication networks that are separate from the centralized management entity, and identify, from the spectrum usage information, first licensed communication resources that are available in a geographic area for radar-sensing operations. The processing circuitry is further configured to manage usage of the first licensed communication resources for radar-sensing operations by mobile radar devices operating in the geographic area as managed devices with respect to the centralized management entity. Managing includes sending grant signaling for individual ones of the managed devices, the grant signaling granting usage of the first licensed communication resources by individual ones of the managed devices.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a computer apparatus according to one embodiment, shown in context for operation of the computer apparatus as a centralized management entity.

FIG. 2 is a diagram illustrating an example arrangement licensed communication resources in two different frequency bands.

FIG. 3 is a block diagram of travel-route segmentation according to one embodiment, for managing usage of licensed communication resources by mobile radar devices operating along a travel route.

FIG. 4 is a diagram illustrating example frequencies comprising licensed communication resources.

FIGS. 5-7 are block diagrams of a computer apparatus operative as a centralized management entity, according to further embodiments.

FIG. 8 is a block diagram of an example arrangement of a centralized management entity that is communicatively coupled to a wireless communication network or to mobile radar devices operating as managed devices.

FIG. 9 is a logic flow diagram of a method of managing usage of licensed communication resources by mobile radar devices, according to one embodiment.

FIG. 10 is a block diagram of an example parameter set considered by a centralized management entity, for determining transmit power and resource reuse, with respect to a mobile radar device using licensed communication resources.

FIG. 11 is a block diagram of a mobile radar device, according to one embodiment.

FIGS. 12A and 12B are a logic flow diagram of a method of managing usage of licensed communication resources by mobile radar devices, according to another embodiment.

FIG. 13 is a logic flow diagram of a method of operation by a mobile radar device, according to one embodiment.

FIG. 14 is a logic flow diagram of a method of operation by a mobile radar device, according to one embodiment.

FIG. 15 is a logic flow diagram of a method of operation by a centralized management entity, according to one embodiment.

### DETAILED DESCRIPTION

Roadways are one example where Mobile Network Operators (MNOs) use, or are likely to use, lower-frequency communication spectrum to provide continuous coverage along the roadway, while using higher-frequency communication spectrum to provide enhanced coverage along selected portions of the roadway. For example, sections of a roadway that pass through or are nearby population densities may have network coverage provided by higher-frequency spectrum to support higher data rates, lower latencies, etc., while sections of the roadway in rural areas may have network coverage provided only by lower-frequency spectrum.

“Spotty” deployment of higher-frequency communication spectrum arises in other contexts and, because of cost and pathloss considerations associated with higher frequencies, there may be many geographical gaps or holes in network coverage with respect to licensed communication resources that are based on higher-frequency spectrum. One example of such higher-frequency spectrum is the spectrum covered by the FR2-1 frequency bands associated with 5G NR networks. An overall geographic area may have network coverage using licensed communication resources that are based on the FR1 frequency bands of 5G NR, while only select, smaller geographic regions within the overall geographic region have network coverage using licensed communication resources that are based on the FR2-1 frequency bands.

A “centralized management entity” employing techniques disclosed herein advantageously permits the use of licensed communication resources in geographic areas where such resources are not used to provide communication services, while harmonizing such usage with adjacent or adjoining areas where they are used for communication services. In this disclosure, the term “licensed communication resources” refers to specific frequencies or frequency bands that are licensed for communication use, e.g., licensed to one or more MNOs for Public Land Mobile Network (PLMN) use. Further, “centralized” connotes the fact that the centralized management entity is external or apart from the wireless communication networks that use the licensed communication resources to provide wireless communication services. Consequently, the centralized management entity may communicate with multiple wireless communication networks owned or controlled by more than one MNO.

Managing usage of licensed communication resources by mobile radar devices for radar-sensing operations may include consideration of any one or more techniques for defining separate or non-conflicting radar-signal transmission resources, such as different modulation schemes, or various multiplexing schemes, including any one or more of time division multiplexing, frequency division multiplexing, code multiplexing, spatial multiplexing, etc. For example, managing usage to avoid conflicting usage of the licensed communication resources by proximate mobile radar devices may include assigning separate frequencies with some minimum frequency spacing or, additionally, or alternatively, assigning different time or frequency multiplexing configurations or hopping patterns, different transmission codes, etc.

Among the several advantages of using licensed communication resources for radar-sensing operations is that doing so makes use of electromagnetic spectrum that is otherwise unused within a given geographic area. Putting such spectrum to use in radar-sensing operations allows for higher densities of mobile radar devices with lowered interference among the devices, as compared to the devices being restricted to frequencies dedicated for radar sensing, such as 77 GHz.

Particular advantages of the “centralized management entity” and associated methods disclosed herein is that the usage of licensed communication resources for radar-sensing operations in a geographic area where those resources are not used for communication services may be coordinated with any number of wireless communication networks that own or otherwise make use of the resources for communication services in surrounding areas. Centralized management also allows for tracking and, optionally, billing for usage of the spectrum for radar-sensing operations, along with controlling usage priorities, e.g. for mobile radar devices affiliated with preferred MNO networks or otherwise having a subscription-based priority.

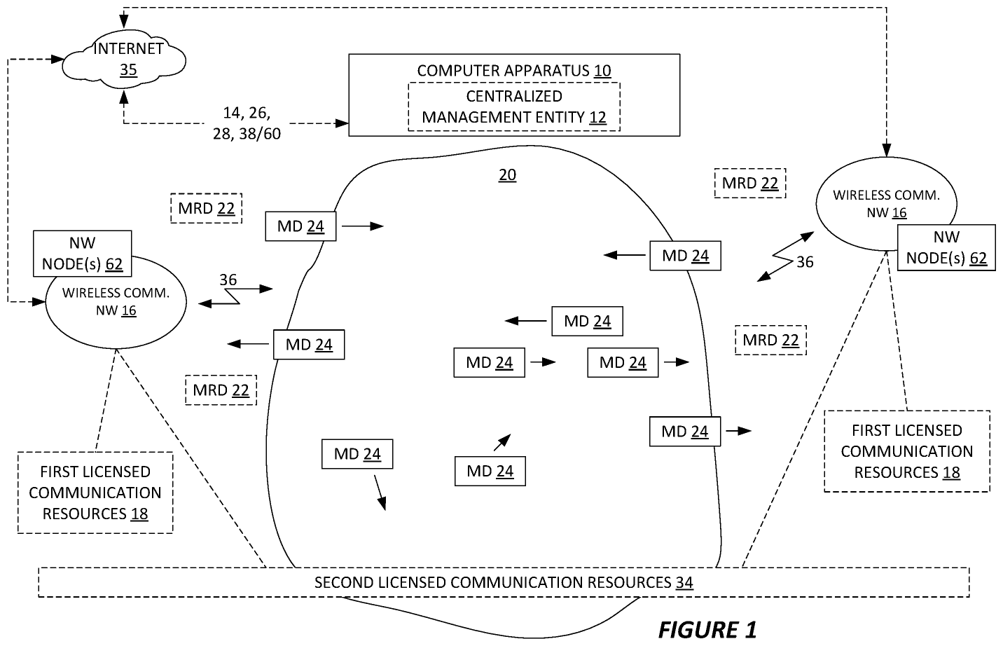

FIG. 1 illustrates a computer apparatus 10 operative as a centralized management entity 12, according to an example embodiment. Particularly, the computer apparatus 10 is programmed or otherwise configured to carry out centralized management operations described herein, to manage usage of licensed communication resources for radar-sensing operations, by mobile radar devices operating in a geographic area where those resources are not used for network coverage—i.e., the license holder(s) do not use the licensed communication resources in the geographic area to provide communication services. Such resources, however, may be used in adjacent or surrounding areas, with the centralized management entity 12 providing advantageous signaling and control with respect to mobile radar devices entering the area, operating within the area, and exiting the area.

The centralized management entity 12 is configured to receive spectrum usage information 14 from one or more wireless communication networks 16 that are at least logically separate from the centralized management entity 12. “Logically separate” here means that centralized management entity 12 is not a functional part of the infrastructure comprising the wireless communication network(s) 16, which networks 16 comprise, for example, cellular communication networks operating according to specifications promulgated by the Third Generation Partnership Project (3GPP). The one or more network(s) 16 are associated with one or more network operators/owners and although the centralized management entity 12 may be physically hosted using equipment that is included in one of the networks 16, in one or more embodiments it provides management services to multiple network operators/spectrum owners.

The centralized management entity 12 is configured to identify, from the spectrum usage information 14, first licensed communication resources 18 that are available in a geographic area 20 for radar-sensing operations. The spectrum usage information 14 in one or more embodiments explicitly identifies the boundaries that define the geographic region 20; in one or more other embodiments, the spectrum usage information 14 provides information that implicitly identifies the geographic region 20 or provides information regarding active network coverage areas and out-of-coverage areas, along with frequency band(s) in use, and the centralized management entity 12 evaluates such data to determine the geographic region 20, the licensed communication resources that are unused for communication services in the geographic region 20, and the networks/network operators that are associated with those resources.

FIG. 1 depicts two wireless communication networks 16, each shown in association with a dashed box labeled as “first licensed communication resources 18”, with this depiction meaning that the first licensed communication resources 18 may be in use in geographic areas outside of or surrounding the illustrated geographic area 20, to provide network coverage—i.e., radio connectivity for communication operations. However, the first licensed communication resources 18 are not used for network coverage within the geographic area 20 and, therefore, are “available” for use for radar-sensing operations within the geographic area 20.

Such availability may be conditioned on or flow from business agreements involving the MNO(s) that own or control the first licensed communication resources 18 and the particular spectrum or conditions on availability may be indicated in the spectrum usage information 14. As noted, the first licensed communication resources 18 comprise electromagnetic spectrum that is licensed for providing wireless communication services, and, in an example case, the first licensed communication resources 18 comprise at least a portion of the frequency bands referred to as the FR2-1 frequency bands in the 5G NR context.

The centralized management entity 12 is configured to manage usage of the first licensed communication resources 18 for radar-sensing operations by mobile radar devices 22 operating in the geographic area 20 as managed devices 24 with respect to the centralized management entity 12. A mobile radar device 22 that uses the first licensed communication resources 18 within the geographic area 20 according to management by the centralized management entity 12 is referred to as a “managed device 24”. There may be mobile radar devices 22 that lack the requisite communication or management capabilities, for direct or indirect management by the centralized management entity 12, and they may operate within the geographic area 20 using transmission resources that are dedicated to radar-sensing operations, without management thereof by the centralized management entity 12. Again, “communication resources” and “transmission resources” both fundamentally refer to specific frequencies or frequency bands—possibly in combination with one or more kinds of multiplexing, such as time, frequency, code, space, etc. However, the term “communication resources” connotes the fact that the frequencies in question are licensed for one or more types of communication services.

Management by the centralized management entity 12 comprises sending grant signaling for individual ones of the managed devices 24, the grant signaling 26 granting usage of the first licensed communication resources 18 by individual ones of the managed devices 24. Management may further comprise the centralized management entity 12 sending termination signaling 28 for managed devices 24 exiting the geographic region 20, the termination signaling 28 terminating the granted usage of the first licensed communication resources 18 by the exiting managed devices 24. Generating the grant signaling 26 comprises, in one or more embodiments, determining non-conflicting configurations or allocations of radar-signal transmission resources, from the first licensed communication resources 18, such as assigning different frequencies or time slots or codes to managed devices 24 that are proximate, to avoid radar interference between them.

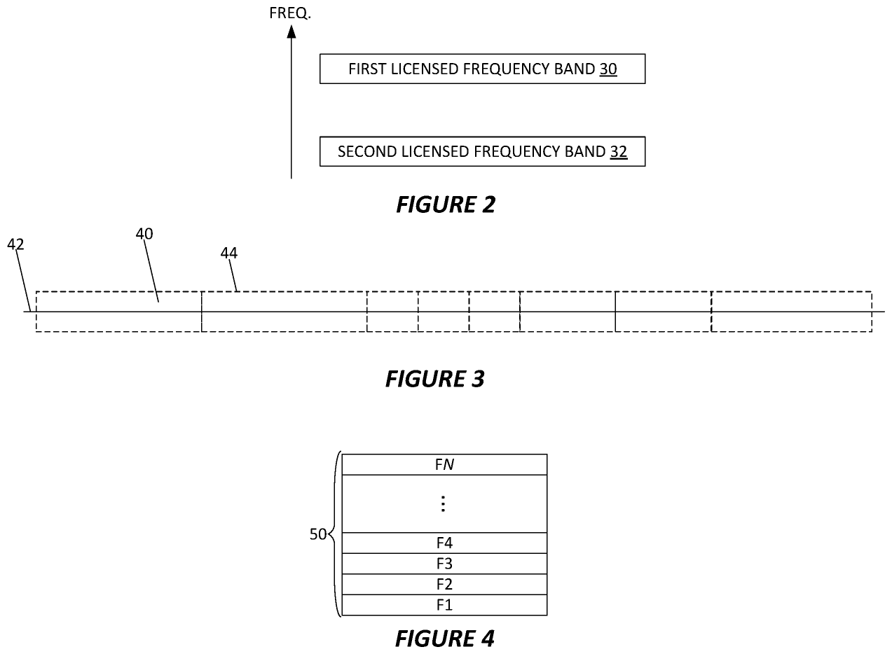

The first licensed communication resources 18 comprise, for example, one or more first licensed frequency bands 30, as shown in FIG. 2, which are not used by the one or more wireless communication networks 16 to provide network coverage in the geographic area 20. However, in at least one embodiment, one or more second licensed frequency bands 32 that are distinct from the first licensed frequency band(s) 30 are used by at least one of the one or more wireless communication networks 16 to provide network coverage in the geographic area 20. The second licensed frequency band(s) 32 are an example of the second licensed communication resources 34 shown in FIG. 1, where the second licensed communication resources 34 may be used to provide network coverage for wireless communications within the geographic area 20. For convenience of discussion, reference hereafter is made to a first licensed frequency band 30 and a second licensed frequency band 32, but it should be understood that there may be multiple such first licensed frequency bands 30 and multiple such second licensed frequency bands 32.

As an example, the FR1 frequency bands are used to provide network coverage for wireless communications within the geographic area 20, while the FR2-1 frequency bands are unused for wireless communication within the geographic area 20. In this context, the illustrated boundary that defines the geographic area 20 may be positioned such that usage of the first licensed communication resources 18 as managed by the centralized management entity 12 for radar-sensing operations terminates well before such operation pose substantive interference risks to wireless communications that make use of the first licensed communication resources 18 in areas adjacent to or surrounding the geographic area 20.

Managing the usage of the first licensed communication resources 18 in one or more embodiments of the centralized management entity 12 comprises communicating with individual ones of the managed devices 24 as protocol endpoints, with communicative coupling to the managed devices 24 via the network coverage provided using the second licensed frequency band 32, e.g., using second licensed communication resources 34. In such an arrangement, the centralized management entity 12 communicates with individual mobile radar devices 22 as managed devices 24, e.g., based on the managed devices 24 including communications circuitry that enables them to exchange signaling with the centralized management entity 12 via the internet 35, which they access using one or more of the wireless communication networks 16 that provide wireless communication services in the geographic area 20.

Managing the usage of the first licensed communication resources 18 in one or more embodiments comprises the centralized management entity 12 communicating with the one or more wireless communication networks 16 as protocol endpoints, which, in turn, exchange signaling 36 with individual ones of the managed devices 24 to effect managed usage of the first licensed communication resources 18 by the centralized management entity 12. Rather than commanding or controlling the managed devices 24 directly, in such embodiments, the centralized management entity 12 is configured to exchange information, such as device identifiers and configuration details about granted usage, with the wireless communication networks 16, and those networks in turn handle the direct communications to the managed devices 24. See signaling 36 in FIG. 1.

In at least one embodiment, the centralized management entity 12 is configured to manage both mobile radar devices 22 that operate under its direct control and mobile radar devices 22 that operate under its indirect control. Here, “direct” means that the centralized management entity 12 generates commands or control signaling targeting the mobile radar devices 22, while “indirect” means that the centralized management entity 12 generates commands or control signaling targeting a base station or other control entity within a wireless communication network that is communicatively coupled to the mobile radar devices 22 in question, with that control entity then controlling the mobile radar devices 22.

Managing the usage of the first licensed communication resources 18 in one or more embodiments includes the centralized management entity 12 exchanging radar handover signaling 38 with one or more of the one or more wireless communication networks 16, with respect to at least one of: mobile radar devices 22 entering the geographic area 20 as new managed devices 24 or mobile radar devices 22 exiting the geographic area 20 as exiting managed devices 24. “Radar handover signaling 38” distinguishes from traditional “communications handover” because it is directed to handover of management responsibility for a mobile radar device 22 that is using or is operative to use licensed communication resources for radar-sensing operations, in locations where such resources are “available” in the sense that they are not used to provide communication services.

Exchanging radar handover signaling 38 with respect to a given mobile radar device 22 entering the geographic area 20 comprises the centralized management entity 12 receiving signaling identifying the given mobile radar device 22 and requesting management of the given mobile radar device 22 by the centralized management entity 12, with respect to usage of the first licensed communication resources 18 with the geographic area 20. Exchanging radar handover signaling 38 with respect to a given mobile radar device 22 exiting the geographic area 20 comprises the centralized management entity 12 sending signaling identifying the given mobile radar device 22 and indicating termination of management of the given mobile radar device 22 by the centralized management entity 12, with respect to usage of the first licensed communication resources 18 within the geographic area 20.

In one or more embodiments, the centralized management entity 12 is configured to send the grant signaling 26 for individual ones of the managed devices 24 by sending configuration information to configure radar-sensing operations by the individual ones of the managed devices 24, with respect to usage of the first licensed communication resources 18 in the geographic area 20. For example, FIG. 3 illustrates an example scenario where the configuration information for a given managed device 24 comprises prospective configuration information comprising configuration information to be used by the given managed device 24 in one or more defined subregions 40 of the geographic area 20. The one or more defined subregions 40 define, for example, respective segments along a defined route of travel 42 being followed by the given managed device 24. The defined route of travel 42 is a roadway, for example, and may support movement in more than one direction, e.g., some mobile radar devices 22 traveling in a northbound direction while other mobile radar devices are traveling along the same route of travel 42 in a southbound direction.

To send the grant signaling 26 for individual ones of the managed devices 24, the centralized management entity 12 in one or more embodiments is configured to send at least initial grant signaling responsive to receiving initial grant requests. An initial grant request is sent by or on behalf of a respective mobile radar device 22, for operation in the geographic area 20 as a managed device 24. The initial grant request includes, for example, an identifier of the mobile radar device 22, and may include any one or more of: radar-signaling capabilities or characteristics of the mobile radar device 22, position, speed, direction, etc. The initial grant response may indicate grant configuration details such as any one or more particular frequencies, modulation schemes, multiplexing patterns, transmit power targets or limits, bandwidth boundaries or limits, to be observed by the mobile radar device 22 when transmitting radar signals in the spectrum of the first licensed communication resources 18. Multiplexing includes any one or more of frequency multiplexing, time multiplexing, and code multiplexing.

Sending the grant signaling 26 for individual ones of the managed devices 24 includes determining usage configurations for individual ones among the managed devices 24, to avoid interfering usage of the first licensed communication resources 18 among the managed devices 24. The centralized management entity 12 may respond to an initial grant request by determining one or more prospective configurations to be used by a mobile radar device 22 as it moves through the geographic area 20 as a managed device 24, and the centralized management entity 12 may send updated configuration information responsive to changing conditions, such as changing weather conditions, deviations from expected paths or rates of travel by given managed devices 24, and detected or reported interference among the managed devices 24. In at least one embodiment, successive grant requests are sent by or on behalf of a managed device 24 as it moves through the geographic area 20, and the centralized management entity 12 is configured to determine a new or updated transmission configuration to be used by the managed device 24 in response to each grant request, e.g., based on dynamically changing location of the managed device 24. Location information may be included in the grant-request signaling or sent separately, for individual ones of the mobile radar devices 22 that are operating as managed devices 24.

To determine the usage configurations for individual ones of the managed devices 24, the centralized management entity 12 in one or more embodiments is configured to determine usage configurations with respect to subregions 40 within the geographic area 20. Each subregion 40 is defined by a bounding box 44 and the centralized management entity 12 determines usage configurations for individual ones of the managed devices 24, to avoid interfering usage of the first licensed communication resources 18 by managed devices 24 within a same bounding box 44 or between adjacent bounding boxes 44. The centralized management entity 12 may consider topology—hills, turns, etc.—when considering whether use of the same frequencies or other resources by respective managed devices 24 causes or is expected to cause interference between the respective managed devices 24.

In one or more embodiments, the centralized management entity 12 is configured to logically divide a defined route of travel 42 within the geographic region 20 into segments, each segment defined by a bounding box 44, and configure usage of the first licensed communication resources 18 by individual ones of the managed devices 24 moving along the defined route of travel 42 on a bounding-box basis, to avoid conflicting usage by managed devices 24. The bounding boxes 44 may be fixed in terms of their geographic associations, such that managed devices 24 moving within the geographic area 20 move through individual bounding boxes 44. However, in one or more embodiments, the bounding boxes 44—i.e., the subregions 40 used for non-interfering allocations of transmission resources—may change in size or shape, responsive to one or more changing conditions. Example conditions include changing densities of managed devices 24 or changes in pathloss, e.g., arising from changing atmospheric conditions.

Also, note that a reuse pattern of resources may be defined over an overall plurality of bounding boxes 44. For example, every fourth bounding box 44 defined along a stretch of roadway may reuse the same subset of resources from the first licensed communication resources 18.

Alternatively, or additionally, the centralized management entity 12 is configured to “attach” bounding boxes 44 to individual managed devices 24, such that the bounding boxes 44 move with the involved managed devices 24. Such an approach may be understood as the centralized management entity 12 creating a “zone” of no reuse immediately around a managed device 24—i.e., the same transmission resources are not reused within a bounding box 44.

Broadly, the bounding boxes 44 used by the centralized management entity 12 in one or more embodiments may be of non-uniform size and may be dynamically resized to account for any one or more of: topological differences among the respective segments, differences in known or expected velocities of managed devices 24 among the respective segments, or differences in managed-device density among the respective segments.

FIG. 4 illustrates a span or portion of the electromagnetic spectrum, which can be understood as a frequency band 50 that includes a corresponding range of frequencies. As noted before, the first licensed communication resources 18 comprise such a frequency band 50, although defining individual transmission resources to be used for radar-sensing operations may involve one or more types of multiplexing, to expand the number of mobile radar devices 22 that can reuse individual frequencies or frequency ranges within the frequency band 50, while avoiding inter-device radar interference.

The centralized management entity 12 in one or more embodiments is configured to manage the usage of the first licensed communication resources 18 by performing at least one of: controlling which frequencies 50 encompassed by the first licensed communication resources 18 are used for radar-sensing operations by individual ones of the managed devices 24, setting transmission power limits or targets for individual ones of the managed devices 24, setting radar-signal bandwidth boundaries for individual ones of the managed devices 24, or setting one or more types of multiplexing parameters for shared usage of common resources among the first licensed communication resources 18 by multiple ones of the managed devices 24.

Turning back to FIG. 1, the centralized management entity 12 in one or more embodiments is configured to manage the usage of the first licensed communication resources 18 by exchanging management signaling 60 with one or more network nodes 62 in the one or more wireless communication networks 16. The network node(s) 62 are responsible for causing corresponding control signaling—see signaling 36—to be exchanged with the managed devices 24. Such signaling 36 may be exchanged using the second licensed communication resources 34, which are used by the one or more wireless communication networks 16 to provide network coverage in the geographic area 20.

Note that the management signaling 60 in one or more embodiments includes radar handover signaling. For example, consider a scenario where a mobile radar device 22 is moving from an area where the first licensed communication resources 18 are used/managed for communications by one of the wireless communication networks 16 (a “serving” network) and into the geographic region 20. The serving network may send radar handover signaling towards the centralized management entity 12, requesting that the centralized management entity 12 begin managing the mobile radar device 22 as a managed device 24, with respect to usage of the first licensed communication resources 18, for radar-sensing operations. Similarly, with respect to a managed device 24 exiting the geographic region 20, the centralized management entity 12 may send handover signaling towards the managed device's serving network—remembering that managed devices 24 may be served by one or more wireless communication networks 16 while they operate within the geographic region 20, via spectrum that is outside the first licensed communication resources 18. Radar handover signaling sent for exiting managed devices 24 comprises, for example, a notification of termination of management by the centralized management entity, which may serve as an implicit request that management be taken over by the serving network.

Note, too, that the centralized management entity 12 may couple directly to the wireless communication networks 16 or through other means, rather than coupling through the internet 35. As such, signaling going between the centralized management entity and the wireless communication network(s) 16 or the mobile radar devices 22 may or may not be routed over internet-based links.

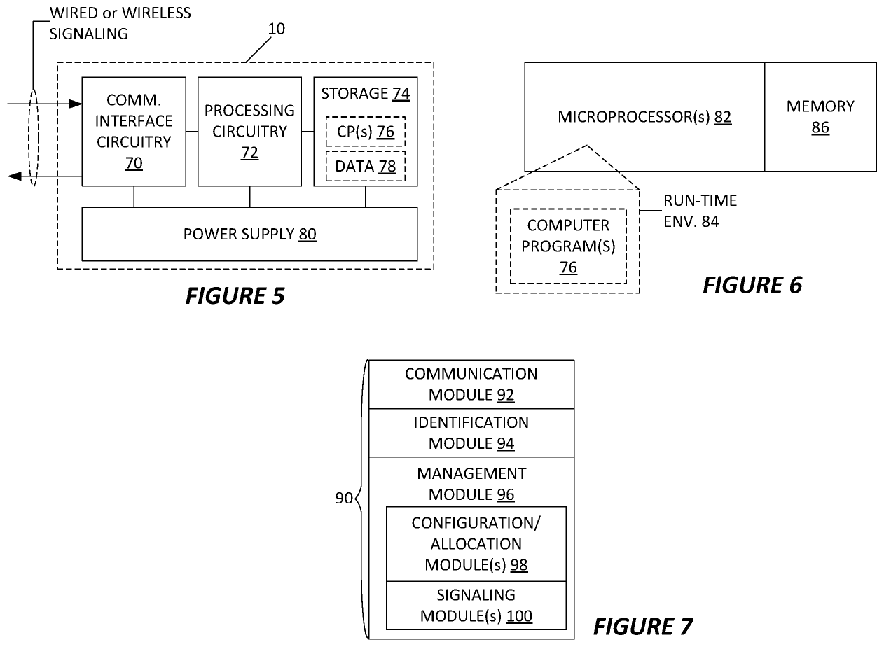

FIG. 5 illustrates the centralized management entity 12 according to an example embodiment. More particularly, FIG. 5 illustrates an embodiment of the computer apparatus 10 that operates as the centralized management entity 12. The computer apparatus 10 includes communication interface circuitry 70, processing circuitry 72, storage 74, which may store one or more computer programs 76 and configuration data 78, and further includes or is associated with a power supply 80.

The communication interface circuitry 70 configured to send and receive signaling via one or more wired or wireless connections, and the processing circuitry 72 is operatively associated with the communication interface circuitry 70. “Operatively associated” means that the processing circuitry 72 uses the communication interface circuity 70 to exchange signaling—e.g., various types of messages—with other entities external to the computer apparatus 10. The processing circuitry 72 may comprise fixed circuitry or programmatically-configured circuitry or some mix of both.

FIG. 6 illustrates that the processing circuitry 72 in at least one embodiment comprises one or more microprocessors 82 that are specially adapted to carry out the functions and actions ascribed herein to the centralized management entity 12, based on the execution of one or more stored computer programs 76. For example, the microprocessor(s) 82 provide a runtime environment 84 for program execution and interact with one or more types of memory 86 that is included in or comprises the storage 74.

With such example implementations in mind, the processing circuitry 72 according to one or more embodiments is configured to: receive spectrum usage information 14 from one or more wireless communication networks 16 that are separate from the centralized management entity 12; identify, from the spectrum usage information 14, first licensed communication resources 18 that are available in a geographic area 20 for radar-sensing operations; and manage usage of the first licensed communication resources 18 for radar-sensing operations by mobile radar devices 22 operating in the geographic area as managed devices 24 with respect to the centralized management entity 12.

To carry out such management, the processing circuitry 72 in at least one embodiment is configured to send grant signaling 26 for individual ones of the managed devices 24, the grant signaling 26 granting usage of the first licensed communication resources 18 by individual ones of the managed devices 24. In at least one embodiment, the processing circuitry 72 is further configured to send termination signaling 28 for managed devices 24 exiting the geographic region 20, the termination signaling 28 terminating the granted usage of the first licensed communication resources 18 by the exiting managed devices 24.

FIG. 7 illustrates another example implementation of the centralized management entity 12, wherein a number of functional or logical processing modules or units are realized based on the execution of computer program instructions by underlying physical hardware—i.e., the illustrated set 90 of processing modules represent software-configured processing circuitry. Example modules include a communication module 92 that is configured to send and receive signaling—e.g., spectrum usage information 14, grant requests, grant responses, configuration information, etc.—an identification module 94 that is configured to identify available licensed spectrum from the spectrum usage information 14, and a management module 96. The management module 96 is configured to manage usage of the available licensed spectrum by mobile radar devices 22 operating as managed devices 24 within the geographic area of availability. As such, in an example implementation, the management module 96 in one or more embodiments includes a configuration/allocation module or modules 98, to decide the particulars of resource grants made to respective managed devices 24, along with a signaling module 100 to handle the incoming and outgoing signaling needed to implement management.

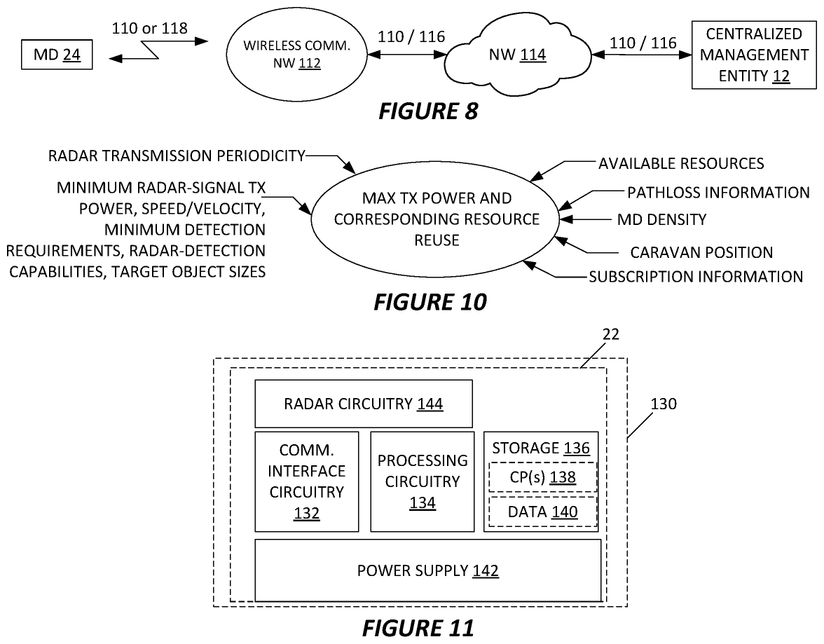

As shown in FIG. 8, the centralized management entity 12 is configured in one or more embodiments to manage the usage of the first licensed communication resources 18 by communicating with the managed devices 24 as communication endpoints. In such embodiments, the centralized management entity 12 generates management signaling 110 targeted to individual ones of the managed devices 24, with such signaling propagated to the managed devices 24 via a wireless communication network 112. The centralized management entity 12 may couple to the wireless communication network 112 through one or more other networks 114, such as the Internet. The wireless communication network 112 may or may not be one of the wireless communication networks 16 shown in FIG. 1—i.e., it may or may not be owned or operated by the license holder authorized to use the first licensed communication resources 18.

In such embodiments, the management signaling 110 going between the centralized management entity 12 and the respective managed devices 24 may be carried transparently through the wireless communication network 112 as user traffic. Alternatively, the centralized management entity 12 communicates with the wireless communication network 112 as a communication endpoint, e.g., it sends management signaling 116 to the wireless communication network 112, and the wireless communication network 112 generates corresponding control signaling 118, to effect—implement—the management decisions being made by the centralized management entity 12.

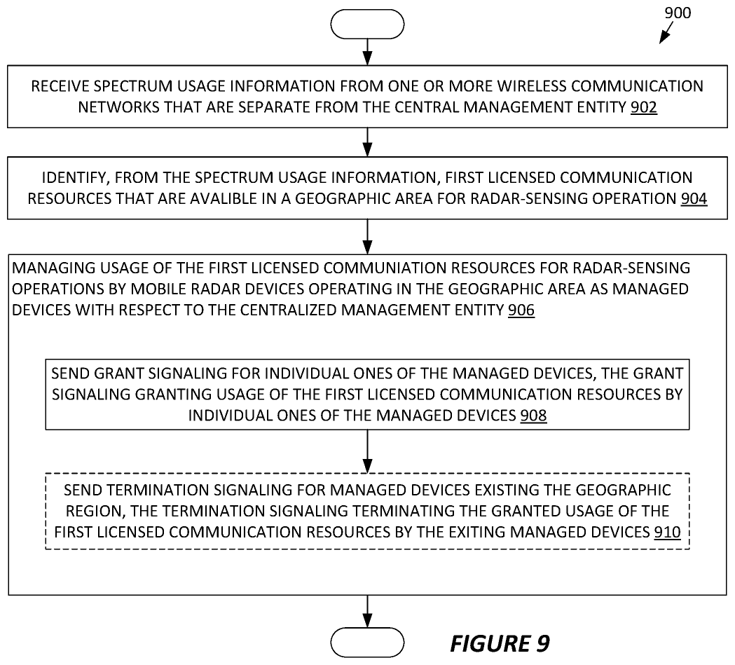

FIG. 9 illustrates a method 900 performed by a computer apparatus 10 operating as a centralized management entity 12, according to an example embodiment. The method 900 includes the centralized management entity 12: receiving 902 spectrum usage information 14 from one or more wireless communication networks 16 that are separate from the centralized management entity 12; identifying 904, from the spectrum usage information 14, first licensed communication resources 18 that are available in a geographic area 20 for radar-sensing operations; and managing 906 usage of the first licensed communication resources 18 for radar-sensing operations by mobile radar devices 22 operating in the geographic area 20 as managed devices 24 with respect to the centralized management entity 12.

Such management comprises the centralized management entity 12 sending 908 grant signaling 26 for individual ones of the managed devices 24, the grant signaling 26 granting usage of the first licensed communication resources 18 by individual ones of the managed devices 24. Optionally, the management further comprises the centralized management entity 12 and sending 910 termination signaling 28 for managed devices 24 exiting the geographic region 20, the termination signaling 28 terminating the granted usage of the first licensed communication resources 18 by the exiting managed devices 24. The method 900 or extensions of it include any one or more of the operations described above for the centralized management entity 12.

FIG. 10 illustrates example parameters considered by the centralized management entity 12 in one or more embodiments, with respect to determining a grant configuration for a given managed device 24. Here, “grant configuration” and similar terms used in this disclosure refer to the particular details of how, when, or where within the geographic area 20 a given managed device 24 is allowed to use the first licensed communication resources 18 to perform radar-sensing operations.

In the example of FIG. 10, the grant configuration includes the determination of a maximum transmit power to be used for radar-signal emissions by the involved managed device 24, along with any corresponding reuse considerations. Example parameters considered by the centralized management entity 12 when determining grant configurations include any one or more of: radar transmission periodicity, minimum radar-signal power requirements, speed or velocity, minimum detection requirements, e.g., object sizes, radar-detection capabilities, available resources, relevant pathloss information, e.g., localized to current or expected locations within the geographic area 20, density of managed devices 24 in the geographic area 20 or subregions thereof, caravan position, and subscription information.

“Caravan position” refers to special cases of platooning or other group travel by vehicles carrying mobile radar devices 22, e.g., based on vehicle-to-vehicle communications. “Convoy” and “caravan” are interchangeable terms in this context. “Subscription information” refers to the fact that in one or more embodiments, some or all usage of the first licensed communication resources 18 for radar-sensing operations is based on the respective mobile radar devices 22 having subscription agreements, directly, or indirectly, that permit such usage. For example, the owner of a vehicle may pay extra so that the radar system(s) of the vehicle are permitted to extend or switch their radar sensing operations into the spectrum represented by the first licensed communication resources 18, e.g., for better or more reliable performance.

Such subscriptions may be add-ons to mobile communication subscriptions, or they may be sold and managed separately. One or more embodiments of the centralized management entity 12 consider subscription information or status, as a basis for allowing or prioritizing usage of the first licensed communication resources 18 by respective mobile radar devices 22.

FIG. 11 illustrates an example of a mobile radar device 22 that is integrated into a larger platform 130, such as a vehicle, drone, or other mobile apparatus, such as smartphones. The mobile radar device 22 includes or is communicatively associated with communication interface circuitry 132, processing circuitry 134, and storage 136, e.g., that stores one or more computer programs 138 that control operation of the platform 130 or mobile radar device 22. The storage 136 may also store data 140, such as subscription information, information about radar capabilities, etc. A power supply 142 supplies power to the various subsystems and radar circuitry 144 is configured to transmit radar signals and receive corresponding return signals, for radar-sensing operations.

With respect to the example mobile radar device 22 of FIG. 11 or others, the centralized management entity 12 makes advantageous determinations of whether certain spectrum can be used within a certain geographical area. In at least some embodiments, the centralized management entity 12 further determines the relationships between different entities controlling spectrum at different areas and provides a scalable and dynamic solution, for allowing mobile radar devices 22 to operate as managed devices 24 within licensed communication spectrum that is not used for communication services within the involved geographic areas 20. The centralized management entity 12 adapts management to changing device densities, changing topology/pathlosses within the geographic area(s), and corresponding consideration of per-device requirements, capabilities, and limits.

Broadly, the techniques disclosed herein exploit a centralized approach that is used to dynamically determine geographical boundaries where higher frequency spectrum is not used for wireless communication services, e.g., not used to provide air interfaces between network base stations and UEs and, hence, can be safely used for other functions. Determining rules for usage may be based on any one or more of: geographical proximity of mobile radar devices 22, predicted routes and distributions of such devices within an area, required transmission powers, dynamics in pathloss, subscriptions, and other device-specific considerations or needs, such as maximum or minimum bandwidth bounds, minimum useful time durations for sensing, one-time allocations, periodic allocations, prospective allocations, etc.

The centralized management entity 12 makes it possible for multiple MNOs or other license holders to coordinate usage of their licensed spectrum in areas where they are not making use of it to provide communication services. Further, because of its operation as a centralized manager, the centralized management entity 12 in one or more embodiments provides seamless initiation and termination (or adaptation) of usage of licensed spectrum for radar-sensing operations, even in instances where the mobile radar devices 22 cross geographic boundaries associated with different license holders.

Other advantages provided by the centralized management entity 12 according to one or more example configurations include any one or more of the following: geo-location-based resources allocation and the use of geographical “boxes” that are not fixed size but instead have sizes that depend on one or more of: the total amount of resources available, device density, which may be detected or predicted, and predicted or known paths of travel by devices. The boxes and the re-use of resources across the boxes depends on radar-signal transmission power and different devices may be allocated different maximum powers. Allowed transmit power may be adapted according to the topology—e.g., higher powers allowed for higher-speed stretches of a roadway and caravanning also may be considered. Broadly, the centralized management entity 12 may size the geographic boxes and control resource reuse among the boxes, in dependence on known or estimated pathlosses. The pathloss could change between different locations along a roadway of other travel path, and different box sizes could be used in e.g. curves, hills, and straight sections, and depending on roadside objects, so that larger boxes are used when the road bends and the risk for interference is less.

Different ones of the mobile radar devices 22 operating as managed devices 24 can have different request types or formats. For example, like managed devices 24 may request resources specifying maximum or minimum bandwidth bounds, minimum useful time duration, one-time or with period allocation, etc., and the centralized management entity 12 can consider all such parameters when deciding whether to grant or deny individual grant requests. Other, less-capable mobile radar devices 22 may send simpler grant requests, and the centralized management entity 12 in one or more configurations uses a default granted configuration when granting requests that do not include or are not accompanied by detailed device information.

In at least some embodiments of the centralized management entity 12, it manages mobile radar devices 22 that are airborne, and it considers inter-device interference scenarios involving airborne devices with respect to each other, and inter-device interference scenarios involving both airborne devices and ground-based devices. For example, depending on its height, beam directions, etc., the centralized management entity 12 allows reuse of transmission resources between a terrestrial device and an airborne device that is operating in the space above the terrestrial device.

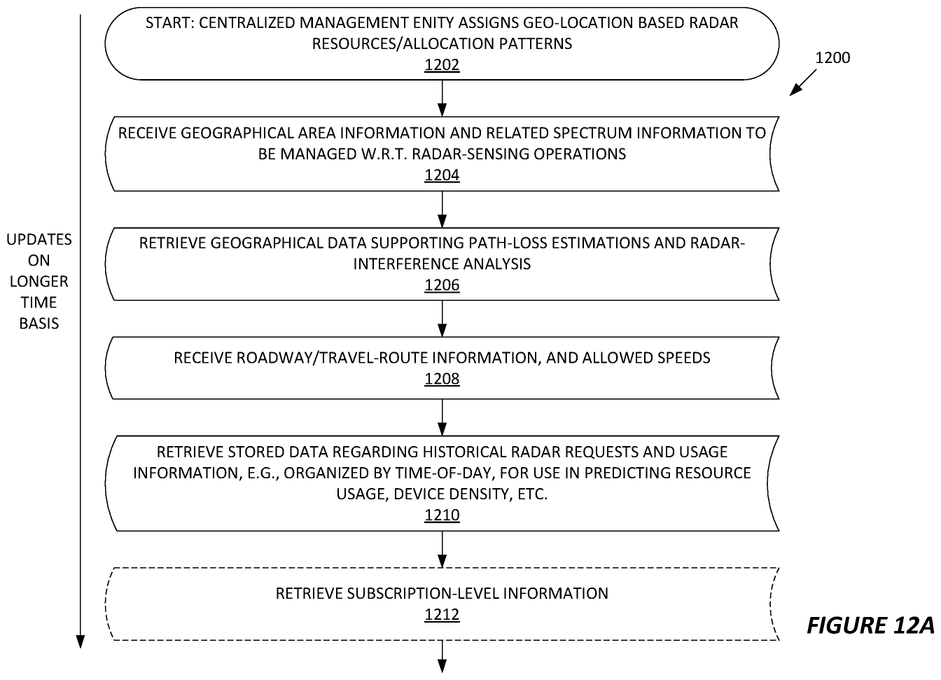

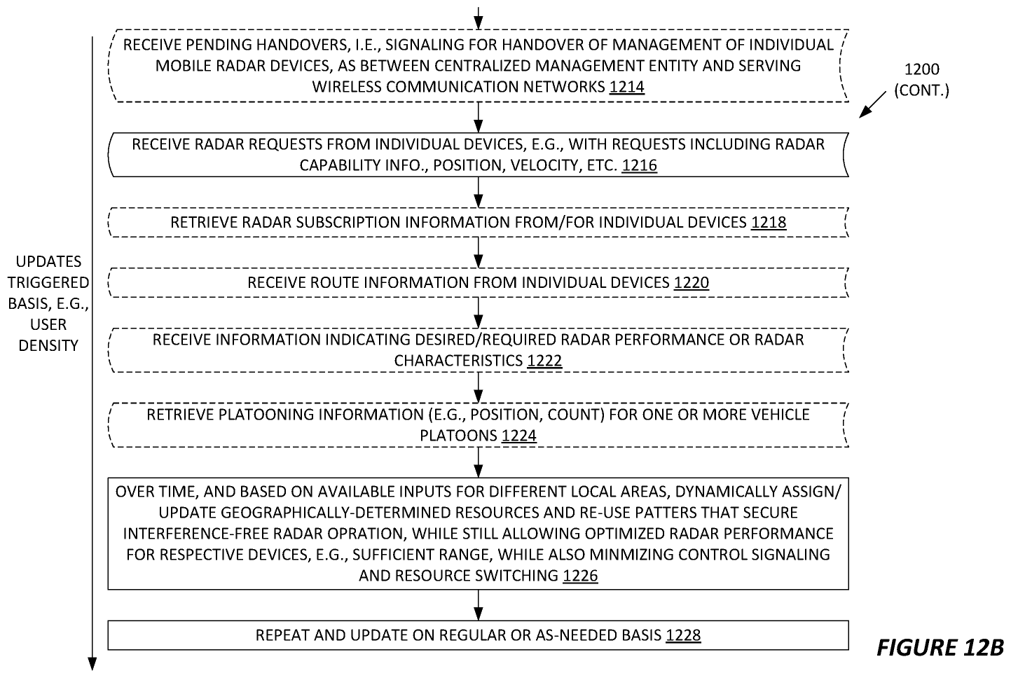

FIGS. 12A and 12B illustrate a method 1200 performed by a computer apparatus, e.g., the computer apparatus 10. FIGS. 12A/B may be understood as an extension or elaboration of the method 900 shown in FIG. 9, and it includes a number of operations that are optional. Overall, the method 1200 comprises as centralized management entity 12 assigning geolocation based radar resources and allocation patterns, using transmission resources comprising first licensed communication resources 18—Block 1202.

Such operation involves the centralized management entity 12 obtaining geographic spectrum utilization information from one or more spectrum owners or operators (Block 1204), and the centralized management entity 12 also may obtain geographic data for use in estimating radar-signal path losses and performing interference analyses (Block 1206). Still further, the centralized management entity 12 may obtain roadway information, such as defined routes, speeds, directions of travel, etc. (Block 1208). Additionally, in at least one embodiment, the centralized management entity 12 retrieves stored data representing historical usage requests, grants, interference incidents, etc. (Block 1210), and it uses such information to predict the extent or pattern of usage for given times of day, etc. In at least one embodiment, the centralized management entity 12 retrieves subscription information for respective devices to be managed, e.g., prospectively, or when needed to respond to a grant request (Block 1212).

The method 1200 in some embodiments includes the centralized management entity 12 receiving radar handing signaling, indicating pending radar handovers for mobile radar devices 22 entering the geographic area(s) being managed by the centralized management entity (Block 1214). Even in embodiments that do not involve explicit radar handover signaling, the centralized management entity 12 receives grant requests from or on behalf of individual mobile radar devices 22 (Block 1216). Such requests may include radar-capability information, device position, velocity, etc.

In embodiments where the centralized management entity 12 considers subscriptions, the method 1200 includes the centralized management entity 12 evaluating radar subscription information, e.g., subscription level or status, which may be used by the centralized management entity 12 to prioritize grant requests, grant or deny such requests, etc. (Block 1218). The centralized management entity 12 may no grant all requests in any given interval, or may defer certain requests, based on prevailing conditions.

In one or more embodiments, the centralized management entity 12 receives route information for mobile radar devices 22 that are or will operate as managed devices 24 within the geographic area 20 (Block 1220). In one or more embodiments, the centralized management entity 12 receives information from or on behalf of respective mobile radar devices 22, indicating desired radar characteristics (Block 1222). In one or more embodiments, the centralized management entity 12 receives caravan or platoon information, for managed devices 24 that are traveling together in an organized fashion (Block 1224). Such information includes, for example, the caravan position of individual managed devices 24.

With the above base information and any optional information received or obtained, the centralized management entity 12 dynamically determines resource assignments and reuse patterns, to secure interference-free radar operation by managed devices 24 performing radar-sensing operations within the geographic area 20, using radar-signal transmission resources comprised within the first licensed communication resources 18 (Block 1226). The overall method 1200 may be repeated regularly or when needed, e.g., on a triggered basis (Block 1228).

One point noted earlier is that mobile radar devices 22 may include or be associated with communication circuitry, such as an embedded user equipment (UE) that has appropriate permissions or stored credentials for accessing wireless communication networks associated with a particular MNO, and, possibly, wireless communication networks associated with one or more other MNOs having roaming agreements with the particular MNO. That is, UEs may have communication-network subscriptions that allow them to access wireless communication networks from one or more MNOs. Radar subscriptions that allow the use of licensed communication resources for radar-sensing operations in areas where such licensed resources are not used to provide communication services may be associated with or subsumed in such communication-network subscriptions. Thus, a mobile radar device 22 that includes an embedded UE having a communication-network subscription with MNO A may be permitted to use licensed communication spectrum for radar-sensing operations in an area controlled by MNO B, based on the inter-MNO coordination provided by the centralized management entity 12.

The centralized management entity 12 may base its timing on a global navigation satellite system (GNSS), or other time base that is used by or relevant to the wireless communication network 16 and the mobile radar devices 22. Positions of mobile radar devices 22 that are entering or already operating within the geographic area 20 as managed devices 24 can be determined according to network-based positioning methods available through the wireless communication network(s) that provide network coverage in the geographic area 20, using communication resources that are outside of the first licensed communication resources 18.

The device positions can be derived from network-based position methods, based on e.g. serving cell ID, Wi-Fi positioning, or on more accurate positioning procedures, or from GNSS receivers within the devices. Device positions may be reported to or determined by the centralized management entity 12 periodically or on a triggered basis, such as when a managed device 24 deviates from its route of travel. Periodic determination/reporting may be configured based on device speed, current location, etc. Note that managed devices 24 may report their positions directly to the centralized management entity 12 or their serving wireless communication networks may report such information. Such information may be GNSS-based, e.g., based on the managed devices 24 including or being associated with GNSS receivers. In cases where the serving networks perform network-based positioning, the serving networks may determine the positions of the managed devices 24 on a recurring or triggered basis using network-based positioning, e.g., multilateration, and report such information to the centralized management entity 12.

For SIB16/SIB9 based distribution of timing information to managed devices 24, RF propagation compensation might be needed dependent on required timing accuracy level and RF propagation delay between individual ones of the managed devices 24 and the respective network base stations that are transmitting the timing information. “SIB” refers to system information blocks as defined for example in 3GPP TS 36.3 21. SIB16 carries information related to GPS time and Coordinated Universal Time (UTC) in the Long Term Evolution (LTE) context, while SIB9 is the corresponding SIB in the New Radio (NR) Fifth Generation (5G) context.

As noted, the grant request sent by or on behalf of a mobile radar device 22 operating as a managed device 24, or seeking operation as a managed device 24, may include information regarding the position, speed, direction, and route of the mobile radar device 22. The grant request may also include request for timing support and may indicate the minimum needed radar-signal transmission power.

If a mobile radar device indicates that it needs positioning support, the centralized management entity 12 in one or more embodiments contacts one or more wireless communication networks that are or will be involved in performing network-positioning of the mobile radar device 22 within the geographic area 20, to initiate network-based positioning of the mobile radar device 22 while it operates within the geographic area 20 as a managed device 24. If the mobile radar device indicates that it needs timing support, the centralized management entity 12 in one or more embodiments initiates timing support. In one example, timing support comprises RF delay compensation.

To the extent that the centralized management entity 12 grants a particular request for a particular mobile radar device 22, it assigns and communicates resource allocation information directly or indirectly to the mobile radar device 22. For example, the centralized management entity 12 pre-schedules resources to be used by the mobile radar device 22 as it travels along a defined route within the geographic area 20. Additional requests may be sent for or by the device or the centralized management entity 12 may on its own decide to update resource allocations for the device, e.g., based on travel-direction changes, changes in speed, or changes in one or more other prevailing conditions, such as increasing or decreasing device densities within subregions of the geographic area 20 relevant to travel of the device. Further, in at least one embodiment, the centralized management entity 12 is configured to terminate an allocation responsive to receiving an indication from the involved managed device 24 that it is terminating radar operations at least with respect to use of the first licensed communication resources 18, or responsive to the centralized management entity 12 determining that the managed device 24 is exiting the geographic area 20.

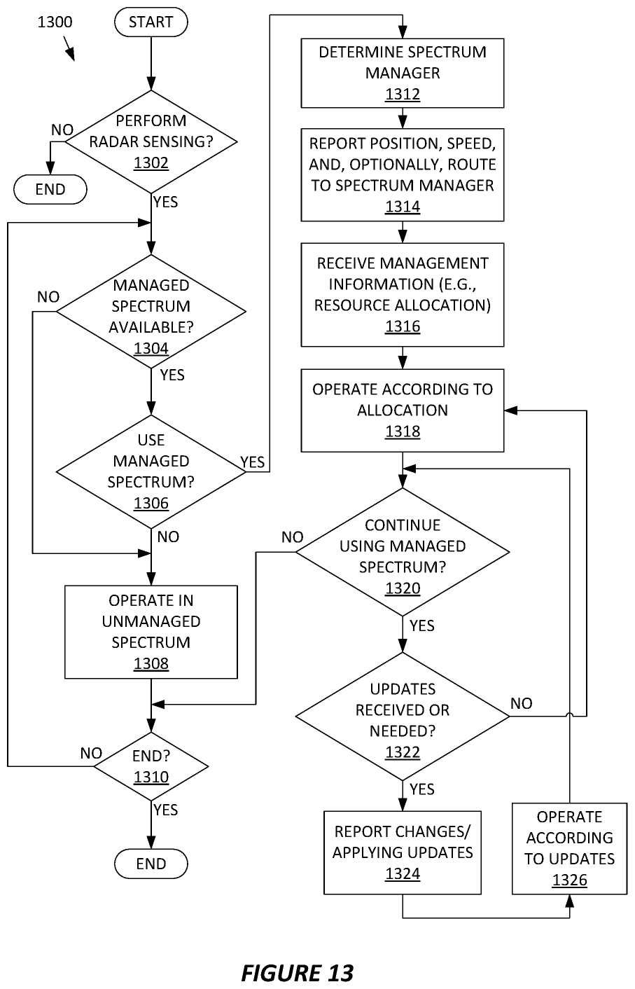

FIG. 13 illustrates a method 1300 that is performed by a mobile radar device 22 according to one embodiment.

The method 1300 begins with the mobile radar device 22 determining whether to perform radar sensing (Block 1302), e.g., at power-on or on a triggered basis. If radar sensing is to be performed (“YES” from Block 1302), the method continues with determining (Block 1304) whether managed spectrum is available. “Managed spectrum” refers to licensed communications spectrum. If managed spectrum is unavailable (“NO” from Block 1304), then processing continues with the mobile radar device 22 operating in unmanaged spectrum (Block 1308). Operating in unmanaged spectrum includes checking, e.g., from time to time or on a triggered basis, whether to continue radar operations and, if so (“NO” from Block 1310), repeating the processing from Block 1304, and, if not (“YES” from Block 1310), ending radar operations.

Responsive to the mobile radar device 22 determining to use managed spectrum for radar sensing (“YES” from Block 1306), processing continues with the mobile radar device 22 determining the spectrum manager (Block 1312). Of course, the mobile radar device 22 may use both managed and unmanaged spectrum at the same time. Regarding use of managed spectrum, the relevant spectrum manager in this embodiment depends on where the mobile radar device 22 is located. If the mobile radar device 22 is within the coverage area where the managed spectrum is used for licensed communications, then the spectrum manager is a node or entity within the involved wireless communication network 16; otherwise, the spectrum manager is the centralized management entity 12.

The mobile radar device 22 reports relevant details (Block 1314), such as any one or more of speed, position, radar capability (band support), requested radar characteristics, and, optionally, route, to the spectrum manager. Processing continues with the mobile radar device 22 receiving (Block 1316) management information, e.g., a resource allocation from the managed spectrum for use by the mobile radar device 22 in radar-sensing operations. The mobile radar device 22 operates according to the allocation (Block 1318), i.e., operates as a managed device 24, and continued processing includes the mobile radar device 22 determining whether to continue using the managed spectrum (Block 1320). For example, the mobile radar device 22 monitors for control signaling from the spectrum manager, indicating that it should end managed operations.

If the mobile radar device 22 ends its use of the managed spectrum (“NO” from Block 1320), it determines whether to end radar sensing operations altogether. If the mobile radar device 22 does not end radar sensing operations, it may, for example, revert to use of unmanaged spectrum. If the mobile radar device 22 continues its use of the managed spectrum (“YES” from Block 1320), its further operations include determining whether updates are needed or have been received (Block 1322). For example, the mobile radar device 22 monitors for the receipt of updated allocation information. As another example, the mobile radar device 22 detects a route change or a significant change in speed, and that change triggers it to request updated allocation information.

If updates are received or needed (“YES” from Block 1322), operations continue with the mobile radar device 22 reporting any changes to obtain the updates, or otherwise applying the updates, assuming they have already been received by the mobile radar device 22 (Block 1324). Processing then continues with the mobile radar device 22 operating according to the updates (Block 1326) and continuing to monitor/determine whether to continue using the managed spectrum (Block 1320).

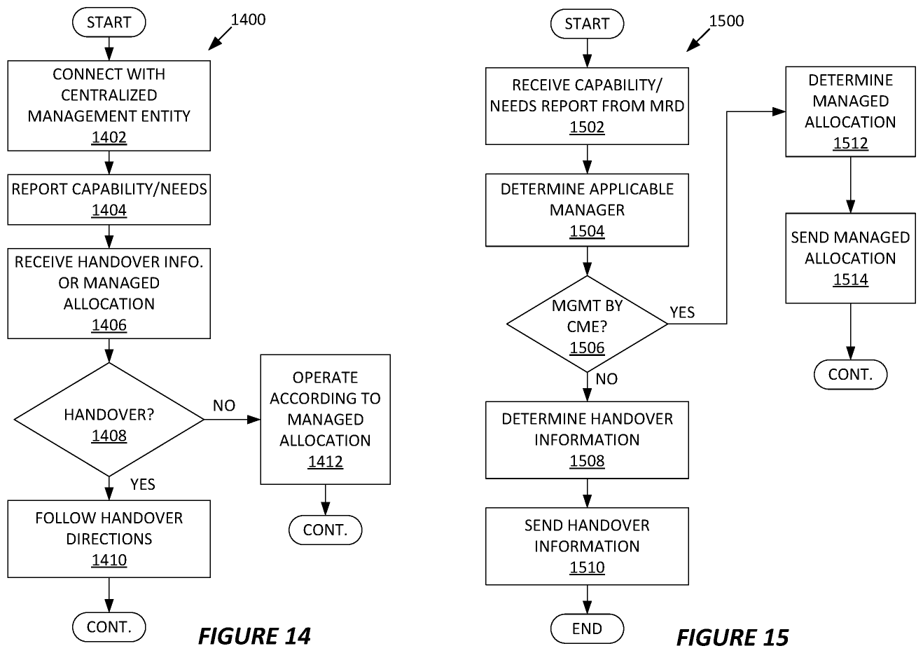

FIG. 14 illustrates another method 1400 of operation by a mobile radar device 22, according to an embodiment. Here, the mobile radar device 22 is configured to contact the centralized management entity 12 on an initial basis, upon deciding to use or attempt to use managed spectrum. The method 1400 may be performed responsive to the mobile radar device 22 deciding that it needs to use managed spectrum or that its radar-sensing operations would be improved via the use of managed spectrum, as compared to operation in unmanaged spectrum.

The mobile radar device 22 connects (Block 1402) with the centralized management entity 12, e.g., using over-the-top (OTT) signaling carried via a wireless communication network 16. The mobile radar device 22 may be pre-provisioned with information needed to contact the centralized management entity 12 or it may receive such information via advertising or other signaling provided by or through the wireless communication network 16.

Processing continues with the mobile radar device 22 reporting (Block 1404) its capabilities or its needs, or both its capabilities and needs. Here, “capabilities” refers to radar-sensing capabilities, e.g., usable frequency bands, etc. In response, the mobile radar device 22 receives (Block 1406) handover information or a managed allocation. The handover information indicates that the centralized management entity 12 is not responsible for managing the managed spectrum with respect to the current location of the mobile radar device 22 and it explicitly or implicitly identifies the entity that is responsible. For example, the handover information indicates the wireless network or network operator responsible for managing the managed spectrum at the current location of the mobile radar device 22. However, if the mobile radar device 22 is currently located in a geographic area 20 where the centralized management entity 12 is responsible for managing the managed spectrum, the information returned to the mobile radar device 22 in Block 1406 comprises a managed allocation (or a management rejection).

For handover (“YES” from Block 1408), the mobile radar device 22 follows the handover directions (Block 1410) and its operations continue accordingly, e.g., by contacting the spectrum manager indicated in the handover directions or otherwise looking for spectrum-management information according to the handover directions. For management by the centralized management entity 12 (“NO” from Block 1408), the mobile radar device 22 operates according to the managed allocation (Block 1412) and its operations continue accordingly, e.g., by monitoring for updated allocation information, sending reports of changed locations, needs, etc.

FIG. 15 illustrates a method 1500 of operation by the centralized management entity 12, according to an embodiment that complements the example operations depicted in FIG. 14 for a mobile radar device 22. Namely, the centralized management entity 12 operates as the initial point of contact for mobile radar devices 22, for use of managed spectrum for radar sensing operations. That is, whether a mobile radar device 22 is within or outside of a coverage area where the managed spectrum is used for wireless communications, it contacts the centralized management entity 12 to gain access to the managed spectrum. Contact between the centralized management entity 12 and the mobile radar device 22 is OTT signaling, for example.

The method 1500 includes the centralized management entity 12 receiving (1502) a capability report or a needs report, or both, from a mobile radar device 22, and the centralized management entity 12 determines (Block 1504) the applicable manager, i.e., it determines whether it will act as the manager with respect to the mobile radar device 22 or if another entity will act as the manager. As a specific example, the centralized management entity 12 uses the location of the mobile radar device 22 to determine whether the mobile radar device 22 is in a location where the centralized management entity 12 is responsible for managing the spectrum at issue, or whether the mobile radar device 22 is in a location where such spectrum is managed by a wireless communication network 16, such as where the wireless communication network 16 co-schedules communication and radar-sensing use of the spectrum.

If the management is by an entity other than the centralized management entity 12 (“NO” from Block 1506), the centralized management entity 12 determines handover information (Block 1508) and sends the handover information (Block 1510). Here, sending the handover information may include sending information to the mobile radar device 22 and to the wireless communication network 16 that will manage the mobile radar device 22. For example, the handover information sent to the mobile radar device 22 explicitly or implicitly indicates that the centralized management entity 12 is not responsible for managing the spectrum at issue, or otherwise indicates the entity that is responsible for such management. Handover information sent to the wireless communication network 16 that is responsible for the management may include identification information for the mobile radar device 22, an indication of its capabilities or needs, or other information that the centralized management entity 12 received from the mobile radar device 22, to facilitate management of the mobile radar device 22 by the wireless communication network 16.

If the centralized management entity 12 is responsible for managing the mobile radar device 22 (“YES” from Block 1506), then processing continues with the centralized management entity 12 determining a managed allocation (Block 1512) and sending information to the mobile radar device 22 that indicates the managed allocation (Block 1514). Here, the “managed allocation” refers to the granted allocation determined by the centralized management entity 12, e.g., in terms of allocated frequency or band, maximum power, etc.

Thus, in an example of an initial request by a mobile radar device 22 towards the centralized management entity 12, the centralized management entity 12 determines, based on, for example, coverage areas, requested radar characteristics, mobile radar device capabilities, radar subscriptions levels, resource availability, position and route information, etc., whether the mobile radar device 22 is best managed by itself or by a wireless communication network 16.

The decision to have management of the mobile radar device 22 by the wireless communication network 16 would generally be based on whether the mobile radar device 22 is within an area where the spectrum in question is shared with communication resources and there is a risk of interference if the mobile radar device 22 is not managed by the same entity that manages communication usage of the spectrum in that area. Different wireless communication networks could have different ways of controlling/assigning resources, and the centralized management entity 12 in one or more embodiments provides the mobile radar device 22 with the necessary information for how to initiate resource requests towards the wireless communication network 16. Further, in at least one embodiment, the centralized management entity 12 forwards already received information about the mobile radar device 22 to the wireless communication network 16.

Based on the particulars of the request from the mobile radar device 22, the centralized management entity 12 could decide the entity best positioned to manage the mobile radar device 22. For example, the centralized management entity 12 may determine from the request that there are multiple frequency bands belonging to different network operators that are available for use by the mobile radar device 22. Particularly, based on the capabilities and the radar subscription level of the mobile radar device 22, and based on the centralized management entity 12 knowing which network operators own or control which frequency bands in which geographic areas, the centralized management entity 12 is well positioned to identify instances when a mobile radar device 22 may be served using resources selected from among multiple network operators or resources that belong to more than one network operator.

As a specific example, the centralized management entity 12 detects instances where a given mobile radar device 22 may be served—managed—in more than one frequency band. The centralized management entity 12 may choose which band is selected based on, for example, the availability of resources in the respective band, which band better suits the current location or direction of travel of the mobile radar device 22, etc. In some circumstances, the centralized management entity 12 may select both bands and manage both of them, or handover management of both of them to the respective spectrum owners, or it may manage mobile radar device 22 in one band and hand over management of the mobile radar device 22 with respect to the other band.

Even if the centralized management entity 12 re-directs management of a mobile radar to a wireless communication network 16, the mobile radar device 22 and the centralized management entity 12 may maintain a connection, such that the centralized management entity 12 receives regular updates from the mobile radar device 22, such as location, speed, needs, etc. The information updates allow the centralized management entity 12 to decide when it should take over management of the mobile radar device 22. Of course, the centralized management entity 12 also may be configured to take over management of a mobile radar device 22 that is currently being managed by a wireless communication network 16, based on receiving handover information for the mobile radar device 22 directly from the wireless communication network 16.

The resource management and resource information provision functions by the centralized management entity 12 may be decoupled. In some setups, even when a wireless communication network 16 performs the management and grants resources to a mobile radar device 22 for performing radar sensing, the mobile radar device 22 may continue using the centralized management entity 12 for requesting resources and receiving resource grants. That is, even with a wireless communication network 16 making the management decisions, the centralized management entity 12 may nonetheless operate as a single point of contact for mobile radar devices 22, for all radar resource coordination.

Such an approach works well with mobile radar devices 22 having OTT/IP based connectivity to the centralized management entity 12, regardless of the particular wireless communication networks 16 that the mobile radar devices 22 are connected with. In such arrangements, while mobile radar device 22 is within an area where the spectrum in question is used for communications, the centralized management entity 12 forwards requests from the mobile radar device 22 to the wireless communication network 16 that controls that spectrum within that area. Correspondingly, the centralized management entity 12 receives resource grants from the managing wireless communication network 16 and forwards them to the mobile radar device 22. Such radar resource coordination may be transparent to the mobile radar device 22. That is, the mobile radar device 22 need not know whether it is being managed directly by the centralized management entity 12, or whether it is being managed by a wireless communication network 16 through the centralized management entity 12. If the interface between the mobile radar device 22 and the centralized management entity 12 runs OTT, the centralized management entity 12 may transparently mediate resources from the wireless communication network 16 through which the mobile radar device 22 is connected or resources that are owned or associated with another wireless communication network 16, or from more than one network.

Similarly, termination of management may be coordinated through the centralized management entity 12, even in cases where the management of the resources in question is handled by a wireless communication network 16.

In at least one embodiment, the centralized management entity 12 is configured to receive a request from a mobile radar device 22 for use of managed spectrum for radar sensing, and the centralized management entity 12 provides the mobile radar device with information indicating coverage area borders. The coverage area borders indicate managed-spectrum areas and the entity/entities responsible for management in each area. The mobile radar device 22 decides, based on the received information of coverage area borders and related management information, and its own position and route, to which management entity it should initiate an initial request. Further, by providing the mobile radar device 22 with the coverage-area information, the mobile radar device 22 can initiate a radar handover request when approaching such a border.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-36. (canceled)

37. A method performed by a computer apparatus operating as a centralized management entity, the method comprising:
receiving spectrum usage information from one or more wireless communication networks that are separate from the centralized management entity;
identifying, from the spectrum usage information, first licensed communication resources that are available in a geographic area for radar-sensing operations; and
managing usage of the first licensed communication resources for radar-sensing operations by mobile radar devices operating in the geographic area as managed devices with respect to the centralized management entity, including sending grant signaling for individual ones of the managed devices, the grant signaling granting usage of the first licensed communication resources by individual ones of the managed devices.

38. The method according to claim 37, wherein managing the usage further comprises sending termination signaling for managed devices exiting the geographic region, the termination signaling terminating the granted usage of the first licensed communication resources by the exiting managed devices.

39. The method according to claim 37, wherein the first licensed communication resources comprise one or more first licensed frequency bands that are not used by the one or more wireless communication networks to provide network coverage in the geographic area, and wherein one or more second licensed frequency bands that are distinct from the one or more first licensed frequency bands are used by at least one of the one or more wireless communication networks to provide network coverage in the geographic area.

40. The method according to claim 39, wherein managing the usage of the first licensed communication resources comprises communicating with individual ones of the managed devices as protocol endpoints, with communicative coupling to the managed devices via the network coverage provided using one or more of the one or more second licensed frequency bands.

41. The method according to claim 39, wherein managing the usage of the first licensed communication resources comprises communicating with the one or more wireless communication networks as protocol endpoints, which, in turn, exchange signaling with individual ones of the managed devices to effect managed usage of the first licensed communication resources by the centralized management entity.

42. The method according to claim 38, wherein managing the usage of the first licensed communication resources includes exchanging radar handover signaling with one or more of the one or more wireless communication networks, with respect to at least one of: mobile radar devices entering the geographic area as managed devices or mobile radar devices exiting the geographic area as exiting managed devices.

43. The method according to claim 42, wherein exchanging radar handover signaling with respect to a given mobile radar device entering the geographic area comprises receiving signaling identifying the given mobile radar device and requesting management of the given mobile radar device by the centralized management entity, with respect to usage of the first licensed communication resources in the geographic area.

44. The method according to claim 42, wherein exchanging radar handover signaling with respect to a given mobile radar device exiting the geographic area comprises sending signaling identifying the given mobile radar device and indicating termination of management of the given mobile radar device by the centralized management entity, with respect to usage of the first licensed communication resources in the geographic area.

45. The method according to claim 37, wherein sending the grant signaling for individual ones of the managed devices comprises sending configuration information to configure radar-sensing operations by the individual ones of the managed devices, with respect to usage of the first licensed communication resources in the geographic area.

46. The method according to claim 45, wherein the configuration information for a given managed device comprises prospective configuration information comprising configuration information to be used by the given managed device in one or more defined subregions of the geographic area, the one or more defined subregions defining respective segments along a defined route of travel being followed by the given managed device.

47. The method according to claim 37, wherein sending the grant signaling for individual ones of the managed devices comprises at least sending initial grant signaling responsive to receiving initial grant requests, wherein an initial grant request is sent by or on behalf of an individual mobile radar device, for operation in the geographic area as a managed device.

48. The method according to claim 37, wherein managing the usage of the first licensed communication resources for radar-sensing operations by mobile radar devices operating in the geographic area as managed devices with respect to the centralized management entity includes determining usage configurations for individual ones among the managed devices, to avoid interfering usage of the first licensed communication resources among the managed devices.

49. The method according to claim 48, wherein determining the usage configurations for individual ones of the managed devices comprises determining usage configurations with respect to subregions within the geographic area, each subregion defined by a bounding box, to avoid interfering usage of the first licensed communication resources by managed devices within a same bounding box or between adjacent bounding boxes.

50. The method according to claim 37, further comprising logically dividing a defined route of travel within the geographic region into segments, each segment defined by a bounding box, and configuring usage of the first licensed communication resources by individual ones of the managed devices moving along the defined route of travel on a bounding-box basis, to avoid conflicting usage by managed devices.

51. The method according to claim 50, wherein the bounding boxes are of non-uniform size to account for any one or more of: topological differences among the respective segments, differences in known or expected velocities of managed devices among the respective segments, or differences in managed-device density among the respective segments.

52. The method according to claim 37, wherein managing the usage of the first licensed communication resources comprises at least one of: controlling which frequencies encompassed by the first licensed communication resources are used for radar-sensing operations by individual ones of the managed devices, setting transmission power limits or targets for individual ones of the managed devices, setting radar-signal bandwidth boundaries for individual ones of the managed devices, or setting one or more types of multiplexing parameters for shared usage of common resources among the first licensed communication resources by multiple ones of the managed devices.

53. The method according to claim 37, wherein managing the usage of the first licensed communication resources comprises communicating with the managed devices as communication endpoints, based on the managed devices being communicatively coupled to the centralized management entity through at least one wireless communication network that provides network coverage over the geographic area using second licensed communication resources that are distinct from the first licensed communication resources.

54. The method according to claim 37, wherein managing the usage of the first licensed communication resources comprises exchanging management signaling with one or more network nodes in the one or more wireless communication networks, and wherein the one or more network nodes are responsible for causing corresponding control signaling to be exchanged with the managed devices using second licensed communication resources used by the one or more wireless networks to provide network coverage in the geographic area.

55. A computer apparatus operating as a centralized management entity, the computer apparatus comprising:
communication interface circuitry configured to send and receive signaling via one or more wired or wireless connections; and
processing circuitry that is operatively associated with the communication interface circuitry and configured to:
receive spectrum usage information from one or more wireless communication networks that are separate from the centralized management entity;
identify, from the spectrum usage information, first licensed communication resources that are available in a geographic area for radar-sensing operations; and
manage usage of the first licensed communication resources for radar-sensing operations by mobile radar devices operating in the geographic area as managed devices with respect to the centralized management entity, including sending grant signaling for individual ones of the managed devices, the grant signaling granting usage of the first licensed communication resources by individual ones of the managed devices.

56. The computer apparatus according to claim 55, wherein, for managing usage of the first licensed communication resources, the processing circuitry further is configured to send termination signaling for managed devices exiting the geographic region, the termination signaling terminating the granted usage of the first licensed communication resources by the exiting managed devices.

57. The computer apparatus according to claim 55, wherein the first licensed communication resources comprise one or more first licensed frequency bands that are not used by the one or more wireless communication networks to provide network coverage in the geographic area, and wherein one or more second licensed frequency bands that are distinct from the one or more first licensed frequency bands are used by at least one of the one or more wireless communication networks to provide network coverage in the geographic area.

58. The computer apparatus according to claim 57, wherein, to manage the usage of the first licensed communication resources, the processing circuitry is configured to communicate with individual ones of the managed devices as protocol endpoints, with communicative coupling to the managed devices via the network coverage provided using one or more of the one or more second licensed frequency bands.

59. The computer apparatus according to claim 57, wherein, to manage the usage of the first licensed communication resources, the processing circuitry is configured to communicate with the one or more wireless communication networks as protocol endpoints, which, in turn, exchange signaling with individual ones of the managed devices to effect managed usage of the first licensed communication resources by the centralized management entity.

60. The computer apparatus according to claim 57, wherein, to manage the usage of the first licensed communication resources, the processing circuitry is configured to exchange radar handover signaling with one or more of the one or more wireless networks, with respect to at least one of: mobile radar devices entering the geographic area as new managed devices or mobile radar devices exiting the geographic area as exiting managed devices.

61. The computer apparatus according to claim 60, wherein, for exchanging radar handover signaling with respect to a given mobile radar device entering the geographic area, the processing circuitry is configured to receive signaling identifying the given mobile radar device and requesting management of the given mobile radar device by the centralized management entity, with respect to usage of the first licensed communication resources with the geographic area.

62. The computer apparatus according to claim 60, wherein, for exchanging radar handover signaling with respect to a given mobile radar device exiting the geographic area, the processing circuitry is configured to send signaling identifying the given mobile radar device and indicating termination of management of the given mobile radar device by the centralized management entity, with respect to usage of the first licensed communication resources with the geographic area.
